(19) United States
(12) Patent Application Publication
(10) Pub. No.: US 2011/0111147 A1
(43) Pub. Date: May 12, 2011

(54) Variable emissivity coatings and their applications

(75) Inventors: Anoop Agrawal, Tucson, AZ (US); Frank W. Loverme, Los Angeles, CA (US)

(73) Assignee: AJJER LLC, Tucson, AZ (US)

(21) Appl. No.: 12/917,073

(22) Filed: Nov. 1, 2010

Related U.S. Application Data
(60) Provisional application No. 61/258,607, filed on Nov. 6, 2009.

(51) Int. Cl. B32B 9/00; C09K 9/00

(52) U.S. Cl. 428/34; 428/697; 252/583

(57) ABSTRACT

This invention describes the applications of variable emissivity materials and their fabrication and incorporation in a variety of structures. In particular, self-regulating energy efficient coatings and products for use in buildings and transportation are disclosed.

### RELATED APPLICATION/CLAIM OF PRIORITY

This application is related and claims priority to provisional application 61/258,607 filed on Nov. 6, 2009; which application is incorporated by reference herein.

### FIELD OF THE INVENTION

The present invention relates to the use of thermochromic coatings which show emissivity changes with changing temperature. Incorporation of these materials improves energy efficiency in various applications.

### BACKGROUND OF THE INVENTION

Infrared emissivity, particularly in the range of about 8 to 14 microns is important for many energy efficient products. When bodies are at or below 120° C., they radiate heat into the surroundings as infrared radiation and most of this radiation is generally between 8 to 14 microns. When the heated bodies are kept in surroundings with low temperature, this radiation is an important energy loss mechanism. As an example, during winter when homes are heated, heat travels to the exterior envelope of the buildings and then part of it is lost by radiation into the atmosphere. For a given environmental situation the magnitude of the radiative loss is dependent on the emissivity of the coating used on the outside of the building structure. Low emissivity coatings will limit the loss and make the structure more energy efficient in cold weather. However, when the building structures heat up during summer, an efficient way to remove the heat before it is conducted to the building interior is to use coatings with high emissivity so that these can radiate a larger amount of absorbed solar heat back into the atmosphere which lowers the energy required for air-conditioning. However, coatings used in buildings have a fixed emissivity and are selected on the average climate of the region if it is cold or heat centered. The use of those coatings where the emissivity will change with temperature, particularly those where it will increase with temperature are useful in further optimizing the energy use to be able to regulate the heat loss or gain in cold or hot weather respectively.

The purpose of this innovation is to disclose materials including coatings that can be used to further improve the energy efficiency of building structures (e.g., by coating interior and exterior walls, windows, roofs and ceilings) and also other applications such as in transportation shells (of cars, buses, trains, planes, boats) that change their emissivity as a function of temperature.

### SUMMARY OF THE INVENTION

In accordance with the purposes of the present invention, as embodied and broadly described herein, the present invention provides materials and method of coating building structures, transportation shells and in other applications that change their emissivity characteristics with temperature, so as to improve the energy efficiency and also increase the comfort of the occupants.

### BRIEF DESCRIPTION OF THE DRAWINGS

FIG. 1a: Cross section schematics of a building window with a variable emissivity layer.

FIG. 1b: Cross section schematics of a building window with a variable emissivity layer and another layer that may be fixed or have a variable emissivity.

FIG. 2a: Schematics of a variable emissivity coating along with an underlying anti-iridescent layer.

FIG. 2b: Schematics of a variable emissivity coating along with an underlying anti-iridescent layer stack.

FIG. 3: Schematics of a building where a technical membrane is used for wall and the roof, and which incorporates a layer with variable emissivity.

FIG. 4: Schematics of a building with variable emissivity coatings on the roof and the walls.

FIG. 5a: shows schematics of a commercial filler particle coated with nano-particles of the variable emissivity material.

FIG. 5b: shows schematics of a commercial particle coated uniformly with the variable emissivity material.

### DETAILED DESCRIPTION

### Application Purpose

Thermochromic materials are known in the art that change their optical properties with temperature. The optical changes can be in the visible range, such as those used as optical indicators when temperature changes, or those that change their properties in the infrared region. The materials of interest for this application are primarily those which reversibly change their optical properties in response to a thermal stimulus, particularly emissivity and reflectivity in the infrared range. Further, the changes in emissivity may be accompanied by changes in reflectivity or absorption in the visible spectral range, however, for many applications those materials are preferred that have no or little color due to absorption in the visible range. Moreover, the emissivity change should preferably be seen in a temperature range of about 0 to 100° C. and in the wavelength range from about 8 μm to about 14 μm, even if part of the change lies outside this wavelength region. Type 1 variable emissivity coatings are defined as those which increase their emissivity with increasing temperature (e.g., BaTi_{1-y}Sn_{y}O₃) and Type 2 variable emissivity coatings are defined as those which decrease their emissivity with increasing temperature (e.g. WₓV₁₋ₓO₂). Those materials are preferred that have an emissivity change of greater than 0.1 between 0 and 100 C, and more preferably a change greater than 0.3 within this temperature range. Typically most of this change occurs within a smaller range of temperature within the desired temperature range mentioned above, wherein the cause of the change is a transition in the structure of the variable emissivity material.

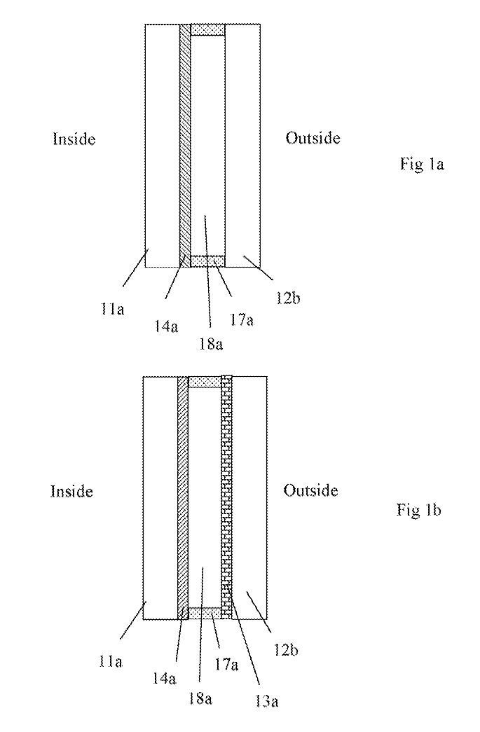

Use of thermochromic coatings for windows have been described in the literature (for example see U.S. Pat. Nos. 7,311,976; 6,872,453; 6,440,592; 6,084,702; 4,425,161; 4,421,560; 4,401,690 and 4,400,412). All of these patents are included herein by reference. U.S. Pat. Nos. 73,119,876 and 6,872,453 discuss thermochromic vanadium oxide layer, where this layer is a part of a multilayer stack and is embedded in the stack along with metal layers, dielectric layers (including oxides and nitrides), and some of the conducting layers may even be used to heat the thermochromic layer to change its properties. This is not preferred in our invention as we would prefer the coatings to change themselves (self regulating) based on the climate. These methods may be used with the preferred thermochromic layers of this invention, however, since our primary interest is in control of IR emissivity of the thermochromic layer, it should not be embedded inside the multilayer structure but be the topmost or the last layer facing a space that comprises of air, gas vacuum, etc. U.S. Pat. No. 6,440,592; 4,401,690 and 4,400,412 discuss processes to deposit vanadium oxide coatings on glass including those compositions that help in decreasing the transition temperature. Some of the preferred vanadium oxide compositions use tungsten, fluorine, niobium, iridium, molybdenum and tantalum as dopants. However, in these patents and in U.S. Pat. No. 6,084,702 vanadium oxide or any other thermochromic layer was always used for its change in absorption in the infrared radiation, and was usually embedded below other layers and thus its emissivity change was not factored in for energy efficient glazing. In some cases an underlying layer such as titanium dioxide was used for promoting growth of vanadium oxide, however, no utility was derived from the interference characteristics provided by the different refractive index of titanium dioxide. These patents mainly describe coatings that comprise of doped vanadium oxide. Vanadium dioxide (including most doped vanadium dioxides) has a yellow color due to absorbance in the visible spectra, and also vanadium's oxidation state as a dioxide is not too stable and with time, this causes its composition and hence the properties to change. FIG. 1a shows a double glazed window (insulated glazing unit or IGU) for a building according to the present invention. An IGU comprises of two or more glass panes that are sealed at the perimeter with a small gap in between and commonly used for windows in buildings. The two glass (or plastic) substrates forming the window are 11a and 12b. These are kept apart by perimeter spacer and/or sealant 17a. The gap between the two substrates is 18a, and 11a is further coated with a Type 1 transparent variable emissivity coating, 14a. This variable emissivity coating has low emissivity when the temperature is low and high emissivity when the temperature is high. The placement of the window relative to the inside of the building and the outside is also shown. When the coating temperature is low in the winter or when it is cold, its low emissivity keeps the building interior heat from radiating outside, and when its temperature is high then it radiates the building heat to the outside. In variable emissivity coatings, the lower emissivity is relative to higher emissivity value, and is generally lower than about 0.1 units and preferably the difference between the low and high emissivity is 0.2 units or greater. Generally the preferred coatings in the lower emissivity state have an emissivity value (in 8 to 14 microns) of about 0.6 or lower and more preferably lower than about 0.5. A preferred range of temperature in which the emissivity of the coatings change most from one temperature to the other for applications important for this invention ranges from about 0° C. to about 40° C., however for a specific application and a geographic location a narrower range within this generic range may be more suitable. Also, those variable emissivity coatings are preferred that impart little or no color to the windows unless desired. The gap 18a between the two panes may be filled with air, vacuum, argon, krypton, nitrogen, sulfur hexafluoride or any gas so that the heat can be transmitted via radiation through this medium.

FIG. 1b shows another embodiment, where Type 1 variable emissivity coating 14a on the outside surface of the inner glazing is shown along with a conventional fixed low-e coating 13a deposited on the inner side of the IGU of the exterior glass pane (or coating stack with low-e properties available from many sources, as an example, Low-e4™ Low-e4 SmartSun™ and Low-e4™ Sun Glass from Anderson, Bayport, Minn.). Conventional fixed low-e (or low-e) coatings are designed to reduce the emissivity of the glass surface. Uncoated glass surface has an emissivity of about 0.84, and typically low-e coatings reduce these to below 0.5, and the high performing low-e coatings more usually below 0.2. This combination as shown in this figure is more useful for heat centered climates. When the outside temperature is warm, the coating 13a limits the heat from outside to be radiated into the gap, and the temperature of 14a may be high so that it is in the high emissivity state and will not restrict any outflow of heat. Similarly, when it is cold that will drop the temperature of coating 14a, it will then drop its emissivity and preserve the building heat. In a cold centered climate a more efficient system is obtained when 14a is a transparent fixed low emissivity coating and 13a is Type 2 transparent variable emissivity coating. Thus conventional low-e coatings (with fixed emissivity) may be combined with the variable emissivity coatings to provide windows with higher energy efficiency.

Use of two coatings where one is variable emissivity and the other is either fixed results in more efficient windows. This concept may be extended to triple glaze windows (or IGU with three or more substrates), and one may use a combination of fixed and variable emissivity coatings on different surfaces.

One may also combine two variable emissivity coatings in a single window, e.g., looking again at the double pane window (or an insulated glass unit, IGU) in FIG. 1b, a good combination will be when coating 14a is Type 1 transparent variable emissivity coating and 13a is Type 2 transparent variable emissivity coating. This will allow lower emissivity in cold conditions for coating 14a and higher emissivity for 13a which will preserve the building heat and will allow the outside heat to be radiated in, and when the warmer conditions prevail, then 14a will have a lower emissivity in restricting the heat from being radiated inside.

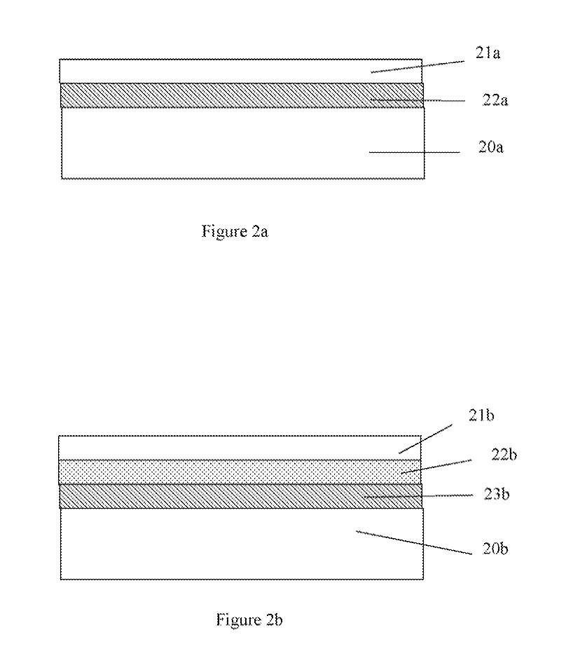

The thickness of the transparent variable emissivity coatings may be so chosen to provide the desired emissivity effect without leading to interference colors, and to this extent these may be combined with thin stacks of coatings with different refractive index to give an anti-iridescent effect (e.g., see U.S. Pat. No. 4,595,634; 4,187,336 and 4,419,386, the disclosures of which are included herein by reference). However in order to preserve the emissivity properties, the variable emissivity layer should always face ambient air or space so that it presents a radiative surface. Anti-iridescent coatings comprise of underlying one or multiple layers of different refractive index coatings as compared to the substrate and the top variable emissivity layer as discussed in the above US patent references. A preferred thickness of the variable emissivity coatings of this invention (including fillers and particles) is generally less than 1,000 nm and typically in the range of 50 to 1,000 nm. For the anti-iridescent effect, a preferred layer structure comprises of one or two additional layers sandwiched between the substrate and the variable emissivity coating. This is shown in FIGS. 2a and 2b. FIG. 2a shows a substrate 20a with a variable emissivity coating 21a and a coating 22a that is sandwiched in between that suppresses the interference colors and is thus an anti-iridescent coating. FIG. 2b shows a substrate 20b with a variable emissivity coating 21b and coatings 22b and 23b that are sandwiched in between that are anti-iridescent coatings. For transparent substrates with a refractive index of 1.5 and a variable emissive layer which has a refractive index of 2.5, the best color suppression due to the interference is obtained by a coating (22a in FIG. 2a) of a material that is about midway in refractive index (RI) of these two (or the average value), i.e., about 2, and with a thickness that results in an optical path length of λ/4, where λ is the wavelength of light. For visible light the wavelength that is usually chosen coincides with the photopic response, i.e. at 550 nm. It is at this wavelength at which the refractive index of the coatings is measured, in case if there is a small difference in the RI value of the variable emissivity coating below and above the transition temperature then preferably an average value is taken. The thickness of this layer with an RI of 2, which will provide an optical path length of λ/4 at normal angle to the surface can be calculated to be 67.5 nm. When this criteria is used, the amplitude of the light reflected from the two interfaces (i.e. substrate and the anti-iridescent coating) and the variable emissivity coating is about the same, and since these are out of phase by λ/2, they cancel each other out (destructive interference) rather than giving the colors. The thickness of the anti-iridescent coating is preferably within 2 to 5% of the above calculated number. However, if there is a slight change in the refractive index of this layer (e.g., greater than about 2%) or the thickness starts exceeding 10% or more, then the colors reappear. Even superior color suppression is achieved by putting two anti-iridescent layers as shown in FIG. 2b. In addition, if the thickness of these layers varies by about more than 25%, only then the colors start becoming more observable. If the refractive index of the substrate is nₛ and that of the variable emissivity coating is nᵥ, the refractive index (n₁) of the layer 22b can be calculated by the expression n₁=nₛ^{0.26}nᵥ^{0.76} and the RI of layer 23b (n₂) can be calculated by the expression n₂=nₛ^{0.76}nᵥ^{0.26}. The thickness of each of these layers to provide an optical path length of λ/4 is then calculated at 550 nm. One may also use additional films of intermediate refractive index, or even a film of graded refractive index (i.e. RI varies continuously from the substrate RI to the variable emissivity coating RI). As described in the above references there are a variety of metal nitrides and oxides that result in optically clear coatings and can be used for anti-iridescent purpose. To obtain a desired RI in an anti-iridescent coating, two or more of different metal oxides or nitrides are mixed, which usually varies linearly with each component. For a mathematical description of the extent of visibility of colors due to interference, one may use color saturation index “c”. The color saturation index c=(a²+b²)^{1/2}, where “a” and “b” are color coordinates on the L.a.b. color scale. When “c” exceeds 12, the colors become observable easily to the human eye, thus it is preferred to keep this value equal to or lower than 10. Typical substrates employed for windows are inorganic glasses (e.g., soda-lime glass) and plastics (e.g., polycarbonate and acrylic).

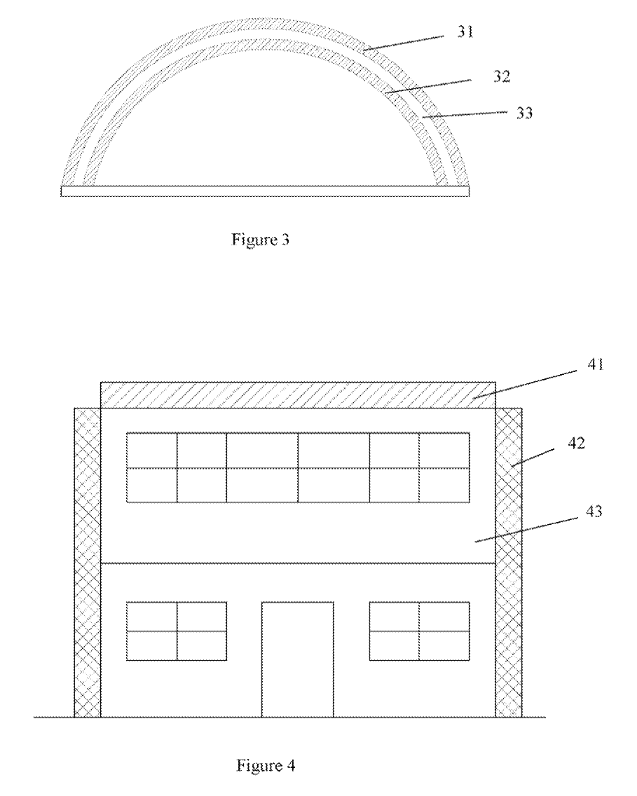

Another way the variable emissivity coatings can be used is to improve the energy efficiency of the building structures. Technical membranes are used for building canopies (see published PCT patent application WO 02/18133, which is included herein by reference) where cloth like membranes are stretched over vast areas, such as airport terminals and stadiums to provide shade from direct sun and climate control inside. Technical membranes may also be used for tents to provide temporary or permanent structures, e.g., those used by the military. These membranes (33) are often coated with low-e coatings 32 (usually fluorinated polymeric coatings with metallic flakes) on the interior surface to provide a comfortable indoor environment, These coatings so reduces the heat that is radiated inside due to the solar heating of the structure. As shown schematically in FIG. 3, these structures (33) could be coated with an additional Type 1 variable emissivity layer (31) on the outside of such membranes so that when the absorbed solar heat during daylight hours increases its temperature (particularly in summer), the coating will radiate the heat more efficiently back into the atmosphere, and when the temperature is low in winter or at night, then the emissivity will be low in order to preserve the heat within the structure and reduce the heating load. One may also only use the variable emissivity coating of Type 1 on the outside (31) and of Type 2 on the inside (32), so that at higher temperatures the Type 2 coating limits the heat radiated on the inside and in cooler weather it radiates the heat inside to decrease the heating load. Generally for buildings, Type 1 coatings are more suitable for the exterior and Type 2 is more suitable for the interior.

In conventional buildings, variable emissivity coatings may also be used for increasing the energy efficiency of the buildings. These are usually paints that result in opaque coatings. These coatings can be used for building roofs and exterior walls. As an example, a Type 1 coating can be used for roofs (41) as shown in FIG. 4 which shows a two story building structure. When the temperature is high, the absorbed solar heat is efficiently radiated back into the atmosphere without having to transmit a large fraction of this energy indoors where it needs to be removed by air-conditioning. When the temperature is low, the absorbed heat is then preferentially transmitted indoors or the building heat is not radiated outside, thus lessening the energy required for heating. The roofs during the daytime can heat due to solar absorption about 25 to 50° C. above the ambient temperatures, and the typical materials used in urban and heat centered climates are those that are light in color to limit solar absorption, and high in emissivity so that absorbed heat is radiated outwards more effectively. The US department of energy specifies materials that can be promoted under the “Cool Roofs” program to decrease heat buildup in urban areas and in the building structures. However, these materials at night and under cooler temperatures perform poorly, as any building heat conducted to the outside is radiated easily into the cold atmosphere. Type 1 material coatings will be very useful in this application as smart materials that self regulate their properties with changing climatic conditions, and have high emissivity when the temperature is high, and low emissivity when the temperature drops in order to preserve the building heat. The same concept can be used for building wall coatings (see 42 in FIG. 4), where these would increase energy efficiency of the buildings. According to 2008 Buildings Energy Databook, from the US Dept of Energy, for residential buildings in US the contribution of the roofs to the heating load is 12% and to the cooling load 14%, similar numbers for walls are at 19% and 10%. We have estimated that if smart materials such as Type 1 coatings are used there is a potential to save about ¼^{th} of the energy that is lost due to the roofs and walls. As discussed later, it is not necessary that one has to use coatings or paints to get the desired surface properties; these properties may also be imparted to extruded sidings. These coatings may also be used for roof tiles, where these are manufactured with these coatings, or they are applied to the tiles by a distributer or by an end-consumer.

Variable emissivity coatings may also be used for transportation (e.g., cars, planes, trains, buses, boats, etc), both in windows, and in paints for their exteriors or shells. The coatings for windows are transparent and for paint applications these are usually opaque. If these are used in transportation windows, they also need to be scratch resistant, as double glazed windows are used less often. For double glazed windows same principles apply as discussed above. For single glazed or laminated windows, Type 1 coatings are suitable for the exterior and Type 2 for the interior. Type 1 coatings are also suitable for exterior finish and paints to increase the energy efficiency, particularly to reduce the energy consumption when the transportation objects are stationary and there is only a limited heat transfer from the exterior surfaces due to convection.

Fillers coated with variable emissivity materials, that are incorporated in inks and prints may also be used for security purposes such as bank notes and documents. One can check the emissivity of these documents with temperature. As discussed later many of these materials exhibit change in emissivity due to a change in crystal structure, which also leads to change in refractive index. Thus, coatings of these materials on fillers (and inks with these fillers) will show a change in interference colors in the visible region with changing temperature, which can be accelerated by use of additional underlying interference coatings.

Fillers with variable emissivity may also be incorporated into fibers that are then used to make textiles and yarns for wearable fabrics or other uses. When Type 1 materials are used, this allows the fabrics at higher temperatures to emit more aggressively and thus keep the fabric cool, while at lower temperatures the lower emissivity retains the body heat. These are particularly useful for outerwear. It has been recently reported (see Lin et al, and Chen et al) that when nanoparticles of fixed emissivity materials are introduced in polymers, the result is lower emissivity material (about 0.5 to 0.6 emissivity) as compared to the polymer matrix which is usually between 0.85 to 0.95 for common polymers.

Materials and Forming of Variable Emissivity Coatings and Objects

The preferred materials that provide variable emissivity are crystalline ceramics and oxides that undergo thermodynamic transitions that have a large influence on the electronic properties, such as insulator to metal or semiconductor to insulator or semiconductor to metal transitions in the temperature range of interest, ferroelectric to paraelectric, etc. These changes are almost always accompanied by a change in crystal structure. For example, barium titanate changes at 130° C. from a ferroelectric to a paraelectric phase with a concomitant change in its crystal structure from tetragonal to cubic. However, we prefer materials for our applications where the change from one to the other phase occurs in a temperature range of 0 to 100° C., and preferably from 10 to about 50° C. Usually the change in the doped materials as described below is gradual and occurs in a range of temperature, thus the peak at which the maximum change occurs is located within the temperature range mentioned. Some of these may also show thermochromic changes in the visible range, but materials with smaller or no changes in visible are preferred (particularly for window and building applications, or any other application where visible change is not desired) in order to keep the appearance uniform and unchanged. There are many such systems, some of which are based on doped barium titanates such as SrₓBa₁₋ₓSn_{1-y}Ti_{y}O_{z}, The value of x and y is usually lower than 0.3, including those where x=0. Another class is RNiO₃ where R is one or more of Pr, Sm, Nd and Gd; SmₓCa₁₋ₓMnO₃ where x is usually equal to or less than 0.5; and RₓVO₂, where R is one or more of W, Mo, Ta, Nb, F, dopant in vanadium dioxide, and the value of X is usually less than 0.4. As an example SrₓBa₁₋ₓSn_{1-y}Ti_{y}O_{z} results in Type 1 system, and VO₂ based materials results in Type 2 system (Liu, Dong-Qing, et al, Advanced Materials Research, Vol 79-82, (2009) p-747 to 750).

Many of the materials that show variable emissivity (Var-e) are used in electronic applications (due to the change in their electronic properties) as bulk materials or as coatings. However, it has not been shown how coatings comprising these materials can be comprehensively utilized to increase the energy efficiency in applications of interest. There are two ways of utilizing these materials, the first is to form uniform coatings of these materials on the desired surfaces, or produce fillers that are made out of these materials or have a coating of these materials on fillers, and then these coated fillers are incorporated in paints, extruded and molded products (e.g., plastic sidings used for buildings). Var-e coatings can be deposited in a number of ways, such as physical vapor deposition, chemical vapor deposition and wet chemical methods (i.e., from solutions of precursors). Any method may be used, however, due to the multielement nature of the coatings, wet chemical methods are preferred where the various precursors of elements are used to prepare homogeneous solutions which are then deposited on substrates or fillers. Crystalline coatings may be formed at low temperature depending on the chemistry used or high temperatures may be required.

Ceramics and metal oxides with Var-e properties have to be formed so that they possess the correct crystal structures in order to function. Typically this requires high heating temperatures (in excess of 600° C.), or chemical reactions at low temperatures but under specific conditions for these materials to crystallize. In a few applications such as ceramic tiles (e.g., for building roofs) and for inorganic oxide based fillers, high processing temperatures are used (typically from 500 to 1300° C.). Thus it is possible to coat these tiles and fillers with precursor solutions and fire or calcine them to these high temperatures so that the crystal structure of the material within the coating is the desired one. Yet in other cases, it may be preferred to form crystalline nanoparticles (usually less than 100 nm in size, and preferably less than 50 nm in size) using low temperature chemical reactions in solutions and then using nanoparticle solutions to coat the surfaces, e.g., transparent coatings for windows, or coating surfaces of fillers that can then be incorporated in paints or plastics. One has to be careful of the dependence of the process used and the minimum nanoparticle size that will possess the correct crystal structure (see Kobayashi, et al). When nanoparticles are used to coat objects, one can get very transparent coatings (e.g., see U.S. Pat. No. 6,020,429; 6,623,791; 6,962,946 and 7,416,781) which are particularly useful for windows. The nanoparticles may be surface modified, or even a small amount of organic binder (usually less than 25% by weight) may be also used. Filler particles may also be coated with precursor solutions, such coatings are then crystallized on the surface by either heating the coated fillers to high temperatures or by chemical changes in solutions. Many of the solution deposition methods will be discussed in more detail. In all of these methods it is important that we maintain a molecular homogeneity of the various elements in order to get materials with the desired compositions rather than phase separated components which may not have the desired properties.

To form these coatings from inorganic oxides formed from the precursor solutions after deposition (by dipping, spraying, etc) require high firing temperature (such as for coating roof ceramic tiles for building). One method to form a precursor coating solution is a polymer-assisted deposition (PAD) which is disclosed in published US Patent applications 20050008777 and 20050043184 and 20080050528 and all included herein by reference. This method results in coating solutions which were stable for months, and provide process control over the coating microstructure including crystallization process.

An advantage of PAD wet-chemical solution deposition processes lies in the role of the polymer used in the solution. In this process, a polymer and the metal salts of the various metal components are dissolved in a common solvent. The polymer binds the metal cations and serves to both encapsulate the metal to prevent further chemical reaction and maintain an even distribution of the metal in solution. This binding results in stable solutions and prevents unwanted reactivity that can lead to the formation of undesired phases. These solutions are stable for months even when multiple metals are used as this binding prevents uncontrolled hydrolysis and condensation. After coating, the object is heat treated or fired using appropriate processing conditions. The metals do not start consolidating almost until the polymer starts decomposing. This preserves the homogeneity and flexibility at the molecular level up to significantly high temperatures. The latter feature makes it possible to grow thicker and crack-free metal-oxide films.

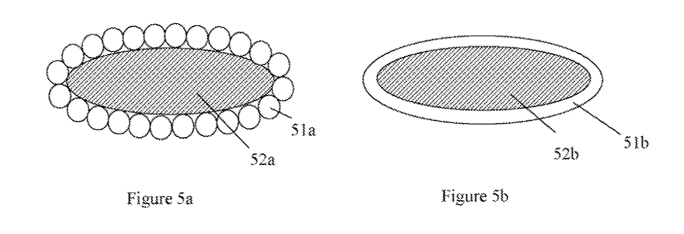

Some of the other methods to coat from solutions use precursors where polymers are not used to bind the metals. One such method involves forming nanoparticles with the required properties and then incorporating this into the final structure (including coatings). This allows for retrofit operations as these coatings and paints do not have to be subjected to high temperatures during processing. The nanoparticles themselves may be incorporated into the product, or these are used to form coatings on filler particles, wherein such filler particles are incorporated into the structures. All of these methods could be used to coat large substrates such as window glass or fillers which can then be incorporated in paints and inks. These methods are schematically shown in FIGS. 5a and 5b. FIG. 5a shows a filler particle (52a) coated with nanoparticles (51a) of the variable emissivity material, and FIG. 5b shows the filler particle (51b) that is coated with a uniform layer of the variable emissivity material (52b). Also, the nanoparticles do not have to form a monolayer coating, and many such layers may be stacked to provide the desired thickness.

Particles (fillers) with variable emissivity properties may be also incorporated into organic (polymeric or paint) coatings in order to provide the variable emissivity properties to these coatings. Thermochromic particles of doped VO₂ were incorporated in paints to change their infrared absorption properties with temperature in U.S. Pat. No. 6,358,307. The issue of emissivity was not discussed on how these particles need to be tailored to get coatings of variable emissivity and in addition there was no discussion of Type 1 materials. Conventional fillers can be coated with variable emissivity materials (Type 1 or Type 2), which are then incorporated into inks and paints. This preference mainly stems on the ease by which the shape of the fillers can be controlled which is important as discussed below. In addition there are producible at an attractive cost. As discussed later, for coatings formed from these paints and inks that exhibit the Var-e properties due to the fillers incorporated into them, the fillers should preferably have a flake or disc like geometry. Even among these fillers, the fillers that are leafing type are preferred. Leafing type fillers are those that due to their surface properties or treatments naturally rise and orient on the free surfaces of the paint or ink coating, providing a high coverage very close to the free surface. The thickness of these fillers may be nanosized or several microns, however, their surfaces in relationship to the thickness are much larger, and may be several 100's of square microns. Some filler examples are silicates and clays including montmorillonite, wollastonite, feldspar, talc, mica, other oxides such as titanium dioxide, chrome oxides, copper oxides, iron oxides, hydroxides such as Al(OH)₃, Mg(OH)₃, and metal flakes such as aluminum, nickel, copper, zinc and their alloys; carbon, graphite and plastic flakes. There are also composite fillers available that are silicates or plastic flakes coated with metals, metal flakes coated with silicates, etc.

As discussed earlier, one can take advantage of the iridescent effect to create fillers of different colors (see Plaff G. et. al., which is incorporated herein by reference) by coating fillers with transparent variable emissivity coatings but of different thicknesses, i.e., thicknesses different from what are required to curb iridescent effects. These fillers when used in paint they can impart visible colors to the paints. If anti-iridescent coatings are used on fillers before depositing the variable emissivity coatings, then their thickness is calculated using the same principles as discussed earlier. The antiiridescent or iridescent coatings can be deposited using the similar approaches as those used for the variable emissivity coatings. However, it is not required that the same method be used for both.

It should be understood that in many building roofing coatings or in pearlescent paints metal flakes (fillers) are used so as to reflect the solar energy in the visible (including UV) and the near infrared (NIR), however, since the emissivity of the metals is usually low, the surface temperatures of these metals increase (e.g., temperature of a chrome buckle in a car can get very hot when the car is parked in a sunny area), which then causes this heat to be transferred by conduction to the interior. However, using this invention one can coat metal fillers so that their reflectivity and color in the visible and the NIR is still about the same, but their surfaces are coated with the transparent materials of this invention which when heated will change the surface emissivity (e.g. increase the surface emissivity with increasing temperature) and allow the heat to be efficiently radiated back into the atmosphere thus making these materials more energy efficient on bright sunny days without compromising their cosmetic appearance.

The same techniques and materials that are described for the formation of the nano-particles or for coating the roofing tiles could also be used to coat the fillers with precursors, and then crystallized either by control of hydrolysis and condensation in solution at low temperatures (typically <200° C. by refluxing), or the coated fillers can be extracted and then calcined to high temperatures (typically >500° C.) to crystallize the coating.

For coating these materials on windows that result in transparent coatings, many methods may be used. Wet chemical methods such as using solutions of nanoparticles are most preferred, as normal soda-lime float glass starts slumping above 400° C. This can be done by spraying, dipping or by meniscus coating. Chemical and physical vapor deposition methods, such as sputtering may also be used.

Example of a PAD Process to Make Coating Solution

In PAD process, a polymer is chosen so that it cleanly decomposes from the matrix under firing conditions to prevent the incorporation of impurities in the coating. Some of the preferred polymers are polyethylenimine (PEI), a substituted PEI such as carboxylated-polyethylenimine (PEIC) or a polymer such as polyacrylic acid, polypyrolidone, and poly(ethylene-maleic acid), polyvinyl acetate and its copolymer with polyvinyl alcohol. PEI or substituted PEIs such as PEIC are generally the preferred polymers. Typically, the molecular weight of such polymers is greater than about 30,000. The precursor solution, used for the deposition includes the soluble polymer and the metal precursors including their salts. Other additives include surfactants, acids and bases to achieve a specific pH. Suitable metal salts may include metal acetates, chlorides, nitrates, metal oxalates, metal acrylates, and metal coordination complexes. The solvent for dissolution of the soluble polymer can be, e.g., water, lower alcohols such as methanol, ethanol, propanol and the like, acetone, propylene carbonate, tetrahydrofuran, acetonitrile, acetic acids and mixtures thereof such as water and ethanol and the like. In some instances, the metal can initially be in a metal complex such as a complex of the respective metal with a metal binding ligand or salt thereof such as ethylenediaminetetraaceticacid (EDTA) or salts thereof such as dipotassium ethylenediaminetetraaceticacid. EDTA-metal complexes are generally soluble within solutions including a soluble polymer with binding properties for the metal precursors such as PEI and the like. Among suitable metal binding ligands besides EDTA and salts thereof can be included other carboxylic acid ligands such as ethylenediaminediaceticacid (EDDA), trans-1,2-diamino-cyclohexan-N,N,N′,N-′-tetraacetic acid (CDTA), ethyleneglycol-O,O′-bis-(2-aminoethyl)-N,N,N′,N-′-tetraacetic acid (EGTA), diethylenetriamine-pentaacetic acid (DTPA), N-(2-hydroxyethyl)-ethylenediamine-N,N′,N′-triacetic acid (HEDTA), nitrilotriacetic acid (NTA), triethylentetramine-N,N,N′,N″,N′″,N′″-hexaacetic acid (TTHA) and the like, polypyridyl ligands such as terpyridine, 2,2′-bypyridine, 1,10-phenanthroline and the like, beta-diketone (acetylacetonate) ligands such as 2,4-propanedione and derivatives thereof, catecholate and aryl oxide or alkyl oxide ligands, macrocyclic ligands such as cyclam, cyclen, triazacyclononane and derivatives thereof, or other simple ligands such as aquo (H₂O) and amines (NH₃), i.e., Co(NH₃)_{6.}²⁺. Shiff-base ligands such as trimethylenediamainetetramethylglyoximato ligand or the salen type ligands may also be used.

To prepare coating solutions to deposit SrₓBa₁₋ₓSn_{1-y}Ti_{y}O_{z} by PAD, the following preparation method can be followed. Due to the high reactivity of titania precursors to hydrolysis two approaches to the solution chemistry are taken. The first involves the use of hexafluorotitanic acid in water bound to polyethylenimine (PEI) as the precursor and the second the use of titanium tetrachloride reacted with 30% hydrogen peroxide and chelated with ethylenediaminetetraacetic acid (EDTA) and bound to PEI or carboxylated polyethylenimine (one half of the amine sites functionalised into carboxylates). Strontium solution is prepared by the addition of strontium nitrate bound to polyethylenimine as an ethylenediaminetetraacetic acid complex as described for the Ti solution. Barium nitrate dissolved in water complexed with EDTA and bound to PEI can be used as the solution precursor for barium oxide. A soluble tin precursor for tin can be prepared by reacting 30% hydrogen peroxide with diacetoxytin (Stannous Acetate) [Sn(O₂C₂H₃)₂] at 0° C. This is then added to a solution of a binding polymer of carboxylated PEI (PEI with one half of the amine sites functionalized into carboxylates) in water. The tin precursor solution is added to this solution and the pH adjusted to 7.5 with 10% NaOH. This process is repeated until addition of the tin solution results in an insoluble precipitate. Each of these solutions can then be passed through the Amicon filter to remove unreacted materials (i.e., if filtration step is used). Amicon ultrafiltration unit containing a PM 10 ultrafiltration membrane can be obtained from Millipore (Bellerica, Mass.), which is designed to pass materials with a molecular weight of <10,000 g/mol. The solutions of the polymer bound to metal is checked for the metal concentration and then the various solutions are mixed in the right stoichiometry to provide the coating solution. As discussed other additives may also be incorporated in this solution that helps with the processing.

Example of Preparation of a Coating Solution with Nanoparticles and Other Precursors and Imparting Leafing Characteristics

This example will be illustrated by using a variable emissivity material, BaSnₓTi₍₁₋ₓ₎O₃ or abbreviated as BTSO. Nonagglomerated crystalline nanoparticles of titanium oxide (anatase) and zirconium oxide in solutions by controlling reaction parameters and precursor interactions, e.g. see published US patent application 20080134939, which is incorporated herein by reference. An important issue in controlling the particle size and avoiding phases rich in specific elements, is the overall concentration of the reactants while also control of hydrolysis and condensation reactions. Preference is given to influencing the hydrolysis with a substoichiometric amount of water, i.e. the molar ratio of water to hydrolyzable groups of the hydrolyzable compounds is less than 1, preferably less than 0.5.

The hydrolysis can be acid- or base-catalyzed, preference being given to acid catalysis. The hydrolysis can be carried out at room temperature (about 25° C.), but is preferably heated in a temperature range of 40 to 200° C. In a preferred method, the hydrolysis is effected with heat and pressure (hydrothermal reaction), for example by heating in a closed vessel. By their nature, suitable reaction conditions depend on the starting compounds used, so that, for example, a wide range of suitable conditions may be appropriate depending on the stability of the starting compounds. The person skilled in the art can select suitable conditions depending on the compounds selected. Some of the preferred precursors for BTSO coatings are TiCl₄, titanium propoxide, Ba(OH)₂ or Ba(NO₃)₂, and SnCl₄. These are dissolved in an organic solvent or an aqueous media. Addition of chelation agents (e.g., polyvinyl acetate, polyethyleneimine, diethanolamine, EDTA, acetic acid and 2,4 pentanedione), heat treatment and the use of catalyst (e.g addition of acids and bases) may be required in order to generate crystalline nanoparticles. Heat treatment is performed mainly by simple refluxing or under pressure and temperature. Nanoparticles formed in this way have their surfaces covered by hydroxyl groups which can then be used to attach these to filler surfaces. Typically, fillers are pre-treated to attach chemical groups on their surfaces so that the surface hydroxides on nanoparticles can react with. Some of the materials used for surface modification are tetraethoxysilane, 1,2 bis(tricholorosilyl)ethane and methylenediphosphonic acid. Conversely, one may also modify the filler surfaces for the nanoparticles to react with, and the pH conditions could be changed in order to condense several layers of nanoparticles on to the filler. Once the nanoparticles are attached to the filler particles, one could react the residual surface hydroxyl groups on the nanoparticles with the desired silanes or acids (e.g. phosphoric acid, fatty acids, such as stearic acid) so that the surface energy of the coated particles can be controlled to yield leafing type of fillers. This is well described in U.S. Pat. Nos. 5,849,072 and 6,761,762, both of which are included herein by reference. The surface treatment for leafing is dependent on the type of polymer that would be used for the matrix of the coating or the solid plastic. For extruded sidings, these fillers due to their shapes align at the high shear region, which is typically the surface of the extruded product.

Types of Fillers for Emissivity Control in Coatings and Sidings.

Most materials used for coatings (paints) are polymeric materials that are insulating. Typically, the emissivity of these materials is in the range of 0.8 to 0.9. Many of the conductive semiconductors and reflective metals have lower emissivity, generally below 0.2. However, when these are mixed in a coating, the emissivity is often determined by the polymeric matrix and is usually above 0.7. In order to have coatings, where the emissivity properties are influenced strongly by the filler, it has been found that fillers with flake or disc type of geometry are superior (see Published PCT patent application WO 02/18113, and Yu (2009), et. al). In addition, fillers that rise to the top of the coating (leafing type) are superior in imparting emissivity characteristics of the fillers to the coatings. Fillers also tend to align in the high shear field experienced at the surfaces of the extruded products. In addition to the variable emissivity fillers along with matrix polymers, the variable emissivity coatings and products, may have other additives including other fillers, colorants and pigments that may be added to get additional properties such as of color, appearance, processing rheology, surface wetting, adhesion, UV and heat stabilization, drying control, cost control, etc. The concentration of the variable emissivity fillers should be as high as possible, and a preferred range is between 10 and 50% by volume. Since emissivity is controlled by surfaces, variable emissivity particles may also be bonded or embedded under heat and pressure on the surfaces of the structures so that the surfaces of the particles are predominantly exposed to the atmosphere.

The fillers may be those that are optically clear, absorbing or reflecting. These fillers may be composed of variable emissivity materials, or these may be coated with variable emissivity materials. Further, some of the preferred fillers are metallic and those that are silicate and oxide based. For example aluminum, nickel, copper and zinc comprising alloys, glass, silica, titania, aluminum oxide and mica to name a few. Further, these fillers may be coated with several layers of materials (with the final layer being of variable emissivity) to get desired optical effects, these could be iridescence as discussed earlier, or may be intensely colored with high luster and may give colors that are angle dependent. Coating fillers, particularly flakes with one or multiple coatings are well established. Flakes are solid materials with shapes where two of its dimensions are much larger than the third dimension. The flake shape of the pigments may be circular, rectangular, or an irregular shape. The size of the flakes, and their distribution of sizes is dependent on the application and the method used to process the paint or an ink comprising these particles. These fillers could be used for powder coatings, automobile paints, printing inks for gravure, offset, screen or flexographic printing, and coatings in building applications such as roofs, exterior and interior. Usually the flakes have a thickness in a range of about 50 to 2000 nm, and the longest dimension of these are typically less than 250 μm (or less than 250 μm in diameter if these are round). These may be uniform in size and shape like coins or these may be irregular, depending on the application and the optical properties needed. For paints to be used in buildings, the flakes are usually oblong and have a size distribution. A preferred surface area of fillers that are plate like (or flake like) in paints is usually less than 200 μm². The distribution of size is dependent on the type of application and the processing used. For example, U.S. Pat. Nos. 7,416,688, 7,255,736 describe these issues in more detail, and these are incorporated herein by reference. Usually, many of the flakes along their face have the long axis that is about 1.2 times or more compared to the shorter axis on an average. Thus, fillers with anisotropic dimensions are also useful for extruded sidings, where fillers with high shear rate regions are typically close to the surface of the extruded product. Depending upon the application these fillers can be adapted in different ways where they may be coated with multiple layers, and with the final layer having the variable emissivity. Multiple layer coatings technology is described in U.S. Pat. Nos. 7,060,126; 6,500,251; 6,156,115 and 6,132,504, which are included herein by reference. These describe how to process and select materials based on their optical characteristics, e.g., the underlying coating(s) may be metallic with high reflectivity, transparent dielectrics with a different refractive index or have specific absorption characteristics.

Fillers with variable emissivity coatings may also be mixed in a matrix with other fillers or have other shapes or even different materials to get different effects. For example U.S. Pat. No. 6,517,628 describes mixtures of fillers where one of the fillers is a coated oxide or a plastic and the other fillers are not coated and may have different shapes, so as to increase the hiding power. All of the teachings and the content of this US patent are included herein by reference. A preferred example of filler with flake geometry of any material is that which is coated with a variable emissivity coating, and combined with other type of fillers in a paint or ink formulation. One of the widely used other type of fillers are titanium dioxide based opacifiers, e.g. titanium dioxide opacifiers may be purchased from Dupont (Wilmington, Del.), such as Ti-Pure® R-101 R-102, R-103, R-104, R-105, R-450, R-706 and R-960. Many of these are doped with other elements or coated with alumina or silica to reduce their photocatalytic effects so that when these are incorporated in paints and inks, they do not degrade the polymeric matrix. As discussed earlier the flake like fillers with variable emissivity coatings may be converted to leafing type by further treatment.

Example of Forming of Plate Like Fillers and Coating them

Plate like fillers of Var-e particles can be obtained naturally or formed synthetically. This example provides one possibility to form plate like fillers that are formed using the precursors of the oxides. For example, solution of BTSO precursors from any of the above examples can be coated as a sheet on a film (e.g. a polymeric film) and dried at low temperatures (usually less than 120° C.). The sheet is then flexed to break and remove the coating as flakes, which can then be heated to any desired temperature to provide flake like particles. Typically to convert these coatings to the right composition and the crystal structure these flakes may be heated to high temperature (usually 500 to 1300° C.) or even formed at low temperature (preferably below 300° C.) by refluxing these flakes in appropriate solvents. U.S. Pat. No. 6,238,472 describes a process to form flakes of titanium dioxide in a thickness of 100±10 nm using a polyester film, this patent is included herein by reference. One may form multiple coatings, wherein the last and/or the first coating is of a variable emissivity material before breaking the flakes off, or one may make flake of any material and then solution coat them with a variable emissivity layer.

Plate like fillers can be transparent materials such as silicates, aluminum oxide, titania, and many other mixed oxides, or these may be colored materials which are coated with a dye or a pigment layer prior to the deposition of Var-e layer, or these may be even colored oxide platelets, such as iron oxides or sulfides, or those made out of metals. Flake fillers, e.g. of titania, mica, aluminum oxide, layered silicates or silica may be coated with a metal layer from a solution to yield reflective particles, wherein the coating metal (e.g., silver is reduced onto the flakes) provides a reflective coating (e.g., see U.S. Pat. No. 6,929,690, which is included herein by reference). The metal coated fillers are filtered washed and then subjected to the next solution which may be Var-e or another material before the Var-e material is deposited. One may use intensely absorbing plates, e.g., carbon and graphite plates that may be coated by Var-e or another material before Var-e material is deposited.

The above variety of fillers, along with the variation in their shapes and sizes can be used to give many different optical effects to the paints and inks that incorporate them, while imparting Var-e properties.

The present invention may be embodied in other specific forms without departing from its spirit or essential characteristics. The described embodiments are to be considered in all respects only as illustrated and not restrictive. The scope of the invention is, therefore, indicated by the appended claims rather than by the foregoing description. All changes which come within the meaning and range of equivalency of the claims are to be embraced within their scope.

1. A variable emissivity coated product comprising of
a. Substrate,
b. Transparent variable emissivity coating
c. Anti-iridescent coating inserted between the said substrate and the variable emissivity coating.

2. A variable emissivity coated product as in claim 1, that is used as a window for a building or in transportation.

3. A variable emissivity coated product as in claim 2, wherein the said window comprises of at least two parallel clear substrates to form an IGU.
Where one of these is coated with Type 1 variable emissivity coating and one of these is coated with either a low-e coating or a variable emissivity Type 2 coating.

4. A variable emissivity coated product as in claim 1, where the product is used as filler for paints and extruded products.

5. A variable emissivity filler to be incorporated in coatings and structures, wherein such a filler is formed by coating particles with a variable emissivity material.

6. A variable emissivity filler as in claim 5, wherein the particles are shaped as flakes or disc like.

7. A variable emissivity filler as in claim 5, wherein the coating comprises of nanoparticles of a variable emissivity material

8. A variable emissivity filler as in claim 5, wherein the filler is of leafing type.

9. A variable emissivity filler as in claim 5, wherein additional coating is present between the particle and the variable emissivity layer.

10. A variable emissivity filler as in claim 9, wherein the additional coating imparts color, reflectivity or antiiridescent properties to the said filler.

11. A variable emissivity paint formulation comprising of variable emissivity fillers in a polymer matrix wherein the volume concentration of the fillers in the said paint formulation ranges from 10 to 50%.

12. A plate like variable emissivity filler that is formed from a precursor solution comprising the steps of depositing the said solution on a substrate, drying the solution and peeling the flakes.

13. A plate like variable emissivity filler as in claim 12, where the peeled flakes are heat treated to high temperatures or refluxed at low temperatures resulting in the desired crystal structures.

14. A variable emissivity coating on the exterior of a building structure, wherein the emissivity of the coating reversibly increases with increasing temperature of the coating in a range of 0 to 100 C.

15. A variable emissivity coating as in claim 14, which comprises of a variable emissivity filler incorporated in a polymer material.

16. A variable emissivity coating as in claim 15, wherein the variable emissivity filler comprises of a particle which does not demonstrate variable emissivity and is coated with at least one coating which demonstrates variable emissivity.
